(19) United States
(12) Patent Application Publication
(10) Pub. No.: US 2019/0212547 A1
(43) Pub. Date: Jul. 11, 2019

(54) FIBER-BASED LASER SCANNER

(71) Applicant: Blickfeld GmbH, Muenchen (DE)

(72) Inventor: Florian Petit, Muenchen (DE)

(21) Appl. No.: 16/328,937

(22) PCT Filed: Aug. 29, 2017
(86) PCT No.: PCT/EP2017/071641

§ 371 Date: Feb. 27, 2019

(30) Foreign Application Priority Data
Aug. 30, 2016 (DE) 10 2016 010 448.1

(51) Int. Cl. G02B 26/10; G01S 17/42; G01S 7/481

(52) U.S. Cl. CPC G02B 26/103; G01S 7/4818; G01S 7/4817; G01S 17/42

(57) ABSTRACT

A movable fiber (201) has a first degree of freedom of movement and a second degree of freedom of movement. An actuator is equipped to induce a first movement of the fiber corresponding to the first degree of freedom during a period of time and to induce a second movement of the fiber corresponding to the second degree of freedom superimposed on the second movement. An optional LIDAR system is equipped to carry out a distance measurement of objects based on the laser light in the surroundings of the device with a plurality of pixels. The pixels are arranged in a two-dimensional image area which is defined by the first movement and the second movement during the period of time. The first movement has a variable amplitude during the period of time.

### TECHNICAL FIELD

Various embodiments relate in general to a fiber-based scanner for laser light. Various embodiments relate in particular to the movement of the fibers according to a first degree of freedom and a second degree of freedom of the movement.

### BACKGROUND

Measuring the distance of objects is a desirable goal in many fields of technology. For example, in conjunction with autonomous driving applications it may be desirable to detect objects in the surroundings of vehicles and in particular to determine the distance from the objects.

So-called LIDAR technology (English: light detection and ranging, sometimes also LADAR) is a technique for measuring the distance of objects, in which pulsed laser light is emitted by an emitter. The objects in the surroundings reflect the laser light. These reflections can then be measured. The distance from the objects can be determined by determining the transmit time of the laser light.

To detect the objects with resolution with regard to position in the surroundings, it may be possible to scan the laser light. Depending on the angle of emission of the laser light, this may make it possible to detect various objects in the surroundings.

However, traditional LIDAR systems with positional resolution have the disadvantage that they may be comparatively expensive, heavy, high maintenance and/or large. A scanning mirror, which can be moved into different positions, is typically used with LIDAR systems. The precision with which the position of the scanning mirror can be determined typically limits the precision of the position resolution of the LIDAR measurement. Furthermore, the scanning mirror is often large and the adjusting mechanism may be expensive and/or high maintenance.

Leach, Jeffrey H., Stephen R. Chinn and Lew Goldberg, Monostatic All-Fiber Scanning LADAR System, Applied Optics, 54(33) (2015), 9752-9757, describe techniques for carrying out a scanned LIDAR measurement by means of an adjustable curvature of an optical fiber. Corresponding techniques are also known from Mokhtar, M. H. H. and R. R. A. Syms, Tailored fiber waveguides for precise two-axis Lissajous scanning, Optics Express, 23(16) (2015), 20804-20811.

Such techniques have the disadvantage that the curvature of the optical fibers is comparatively limited. Furthermore it may be difficult to implement optics to prevent beam divergence of laser light emerging from the end of the optical fiber.

### SUMMARY

Therefore there is a demand for improved techniques for measuring the distance of objects in the surroundings of a device. In particular there is a demand for such techniques which eliminate at least a few of the aforementioned restrictions and disadvantages.

In one example, a device comprises a movable fiber. The movable fiber has one first degree of freedom of movement and one second degree of freedom of movement. The fiber is set up to deflect laser light. The device also comprises at least one actuator. The at least one actuator is equipped to induce a first movement of the fiber according to the first degree of freedom during a period of time. Furthermore, the at least one actuator is equipped to induce a second movement of the fiber accordingly during the period of time, the second movement being superimposed on the first movement according to the second degree of freedom. Furthermore the device comprises a LIDAR system which is equipped to carry out a distance measurement of objects in the surroundings of the device having a plurality of pixels based on the laser light. The pixels are arranged in a two-dimensional image area. The image area is defined by the first movement and the second movement during the period of time. The first movement has a variable amplitude during the period of time.

In another example, a method comprises inducing a first movement of a fiber according to a first degree of freedom of the movement of the fiber. The method also comprises inducing a second movement of the fiber according to a second degree of freedom of the movement of the fiber. Inducing the first movement and inducing the second movement take place during a period of time such that the first movement and the second movement are superimposed. The fiber deflects laser light. This method also comprises carrying out a distance measurement of objects in the surroundings based on the laser light and with a plurality of pixels. The pixels are arranged in a two-dimensional image area defined by the first movement and the second movement during the period of time. The first movement has a variable amplitude during the period of time.

The features defined above and the features described below may be used not only in the corresponding explicitly explained combinations but also in other combinations or isolated without going beyond the scope of protection of the present invention.

### BRIEF DESCRIPTION OF THE FIGURES

FIG. 1A illustrates schematically a device equipped to carry out a scanned distance measurement of objects in the surroundings of the device according to various embodiments, wherein the device has an emitter for laser light, a detector for laser light and a LIDAR system.

FIG. 1B illustrates schematically the device according to FIG. 1A in greater detail, wherein the device comprises a scanning device equipped to scan the laser light.

FIG. 2 illustrates schematically a scanning device having a fiber with a movable end according to various embodiments.

FIG. 3A illustrates schematically a scanning device with a fiber having a movable end according to various embodiments, wherein FIG. 3A illustrates a curvature of the fiber.

FIG. 3B illustrates schematically a scanning device with a fiber having a movable end according to various embodiments, wherein FIG. 3B illustrates a torsion of the fiber.

FIG. 4A illustrates schematically a scanning device with a fiber having a movable end according to various embodiments.

FIG. 4B illustrates schematically a scanning device with a fiber having a movable end according to various embodiments.

FIG. 4C illustrates schematically a scanning device with a fiber having a movable end according to various embodiments.

FIG. 4D illustrates schematically a scanning device with a fiber having a movable end according to various embodiments.

FIG. 5 illustrates schematically the superimposed figure of the fibers obtained by means of a first movement according to a first degree of freedom and a second movement of the fiber, corresponding to a second degree of freedom, superimposed on the first movement, wherein the superimposed figure does not have any nodes.

FIG. 6 illustrates schematically the amplitude of the first movement and the second movement for the example of FIG. 5 according to various embodiments.

FIG. 7 illustrates schematically the amplitude of the first movement and the second movement for the example of FIG. 5 according to various embodiments.

FIG. 8 illustrates schematically a first resonance curve with a first resonance maximum for the first movement and also illustrates schematically a second resonance curve with a second resonance maximum for the second movement, wherein the first resonance curve and the second resonance curve have an overlap range according to various embodiments.

FIG. 9 illustrates schematically a weight applied to the fiber according to various embodiments.

FIG. 10 illustrates schematically the deflection of the fiber for a transverse mode of the first order as well as for a transverse mode of the second order according to various embodiments.

FIG. 11 illustrates schematically the superimposed figure of the fiber obtained by means of a first movement according to a first degree of freedom and a second movement of the fiber according to a second degree of freedom superimposed on the first movement, wherein the superimposed figure has a node.

FIG. 12 illustrates schematically a stop, which limits the deflection of the fiber according to various embodiments.

FIG. 13 is a flow chart according to various embodiments.

### DETAILED DESCRIPTION OF EMBODIMENTS

The properties, features and advantages of this invention is described above as well as the manner in which these are achieved are understandable more clearly and distinctly in conjunction with the following description of the embodiments which are explained in greater detail in conjunction with the drawings.

The present invention is explained in greater detail below on the basis of preferred embodiments with reference to the drawings. The same reference numerals identified in the figures denote the same or similar elements. The figures are schematic representations of various embodiments of the invention. Elements depicted in the figures are not necessarily drawn true to scale. Instead the various elements illustrated in the figures are reproduced in such a way that their function and general purpose are understandable to those skilled in the art. Connections and couplings between functional units and elements illustrated in the figures may also be implemented as indirect connections or couplings. A connection or coupling may be implemented in a hard wired form or in a wireless version. Functional elements may be implemented as hardware, software or a combination of hardware and software.

Various techniques for scanning light are described below. The techniques described below can permit for example, two-dimensional scanning by light. The scanning can refer to repeated emission of light at different emission angles. The scanning may refer to the repeated scanning of different points in the surroundings by means of the light. For example, the quantity of different points in the surroundings and/or the quantity of different emission angles define an image range.

In various examples, scanning of light may be carried out by the chronological superpositioning of two movements according to different degrees of freedom of movable element. Therefore a superimposed figure can be carried out in various examples. In some cases the superimposed figure may also be referred to as a Lissajous figure. The superimposed figure may describe a sequence in which the different emission angles are implemented.

In various examples it is possible to scan laser light. For example, coherent or incoherent laser light may be used. It would be possible to use polarized or unpolarized laser light. For example, it would be possible for the laser light used to be pulsed. For example, short laser pulses with pulsed widths in the femtosecond or picosecond or nanosecond range could be used. For example, a pulse duration might be in the range of 0.5 to 3 nanoseconds. The laser light may have a wavelength in the range of 700-1800 nm. For reasons of simplicity, reference is mainly made below to laser light. However, the various examples used herein may also be used for scanning light from other light sources, for example, broadband light sources or RGB light sources. RGB light sources herein refer in general to light sources in the visible spectrum with the color space being covered by superpositioning of a plurality of different colors—for example, red green blue or cyan, magenta yellow or black.

A movable end of a fiber-shaped element, i.e., a fiber is used in various examples. For example, light fibers which are also referred to as glass fibers may be used. However, it is not necessary for the fibers to be made of glass. For example, the fibers may be made of plastic, glass, silicon or some other material. For example, the fibers may be made of quartz glass. For example, the fibers may be exposed in a lithographic process from a wafer, for example, a silicon wafer or an SOI wafer (English: silicon-on-insulator wafer). An etching technology may be used for this purpose. For example, the fibers may have a 70 GPa elasticity module. For example, the fibers may allow up to 4% stretching of the material. In many examples, the fibers have a core in which the laser light fed into it propagates and is enclosed by total reflection at the edges (light waveguide). However, the fiber need not have a core. In various examples, so-called single-mode fibers or multimode fibers may be used. The various fibers described herein may have a circular cross section, for example. It would be possible, for example, for the various fibers described herein to have a diameter no smaller than 50 μm, optionally not <150 μm, more optionally not <500 μm, more optionally not <1 mm. For example, the various fibers described herein may be designed to be bendable and/or curvable i.e., flexible. To do so, the material of the fibers described herein may have a certain elasticity.

For example, the movable end of the fiber may be moved in one or two dimensions. For example, it would be possible for the movable end of the fiber to be tilted with respect to a fixation point of the fiber. This results in a curvature of the fiber. This may correspond to a first degree of freedom of movement. Additionally or alternatively, it would also be possible for the movable end of the fiber to be rotated along the axis of the fiber (torsion). This may correspond to a second degree of freedom of movement. By moving the movable end of the fiber, it is possible to achieve the result that the laser light is emitted at various angles. It is therefore possible to scan surroundings with laser light. Depending on the intensity of the movement of the movable end, image areas of the different sizes can be implemented.

In the various examples described herein, it is possible to implement torsion of the movable end of the fiber alternatively or additionally to yield a curvature of the movable end of the fiber. In other examples, other degrees of freedom of movement can also be implemented.

In various examples described herein, the fiber is used as a holder for a deflecting unit. The deflecting unit can be mounted rigidly and/or in a stationary position on the movable end of the fiber. However, the laser light can then reach the deflection unit by a different optical path than that of the fiber. In other words, the fiber does not necessarily serve as an optical waveguide for the laser light on its path to the deflecting unit. If the laser light does not reach the deflecting unit through the fiber, a complex and difficult input of laser light into the fiber can be avoided. Furthermore, it is possible to use laser light which not only has the local TEM00 mode, for example, but additionally or alternatively has other modes as well. This can make it possible to use a particularly small laser for example, a laser diode.

For example, the deflection unit may be implemented as a prism or a mirror. For example, the mirror may be implemented by a wafer such as a silicon wafer or a glass substrate. For example, the seal may have a thickness in the range of 0.05 μm to 0.1 mm. For example, the mirror may have a thickness of 25 μm or 50 μm. For example, the mirror may have a thickness in the range of 25 μm to 75 μm. For example, the mirror may be designed to be square, rectangular or circular. For example, the mirror may have a diameter of 3 mm to 6 mm.

In general, such techniques can be used for scanning light in a wide variety of fields of application. Examples include endoscopes and RGB projectors and printers. In various examples, LIDAR techniques can be used. The LIDAR technique may be used to carry out a high-resolution distance measurement on objects in the surroundings. For example, the LIDAR technique may include transit time measurements of the laser light between the movable end of the fiber, the object and a detector.

Although various examples have been described with respect to LIDAR techniques, the present patent application is not limited to LIDAR techniques. For example, the aspects described herein with respect to scanning laser light by means of the movable end of the fiber may also be used for other applications. Examples include, e.g., the projection of image data in a projector—where an RBG light source could be used, for example.

Various examples are based on the finding that it may be desirable to scan the laser light with a high precision with respect to the emission angle. For example, in conjunction with LIDAR techniques, resolution of the distance measurement may be limited by an inaccuracy in the emission angle. A higher (lower) resolution is typically achieved, the more accurate (less accurate) the determination of the emission angle of the laser is.

Techniques for achieving a particularly efficient scanning of the surroundings when using fiber-based scanners are described below. Techniques for adjusting a superimposed figure of a fiber excited in two degrees of freedom are described in various examples. For example, the superimposed figure may be selected so that an image range for the two-dimensional LIDAR images can be supplied and can be scanned uniformly with pixels.

In various examples, the amplitude of a first movement, which corresponds to a first one of the two degrees of freedom is altered (English: ramped). The change takes place over a period of time corresponding to the scanning of the image range. For example, it would be possible for the amplitude to be increased monotonically or decreased monotonically. For example, the change may take place continuously or in stages. Due to the change in the amplitude, the superimposed figure can be adjusted in a particularly flexible manner. For successive LIDAR imaging, the change in the amplitude of the first movement can be carried out repeated.

In many examples, it would thus be possible to drive the first degree of freedom of the movement in increments—i.e., nonresonantly. However, the second degree of freedom of the movement may be driven by resonance. Therefore, the superimposed figure can be adjusted in a flexible manner. For example, the center of a resonant second movement can be adjusted in increments according to the second degree of freedom of movement by a nonresonant first movement. For example, a resonant torsion mode of the fiber as the second movement may be superimposed on a nonresonant stepwise torsion of the fiber.

The amplitude of the second movement, which corresponds to the second of the two degrees of freedom, can also be varied. However, the amplitude of the second movement may also remain constant or may be altered comparatively little in comparison with the alteration of the first amplitude, for example, by less than 20%, optionally by less than 5%, further optionally by less than 1%.

In other examples—for example, if no stepwise adjustment is used—it may be possible for the frequencies of the first and second movements to be coordinated with one another. This could make it possible to prevent nodes in the corresponding superimposed figure. It is possible in this way for certain image areas to be scanned repeatedly.

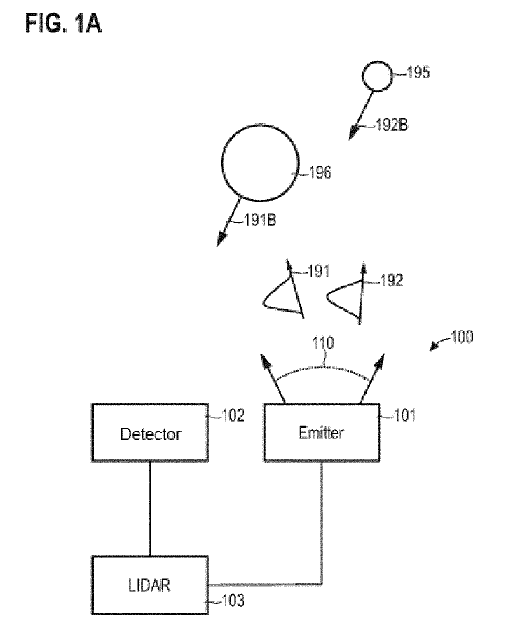

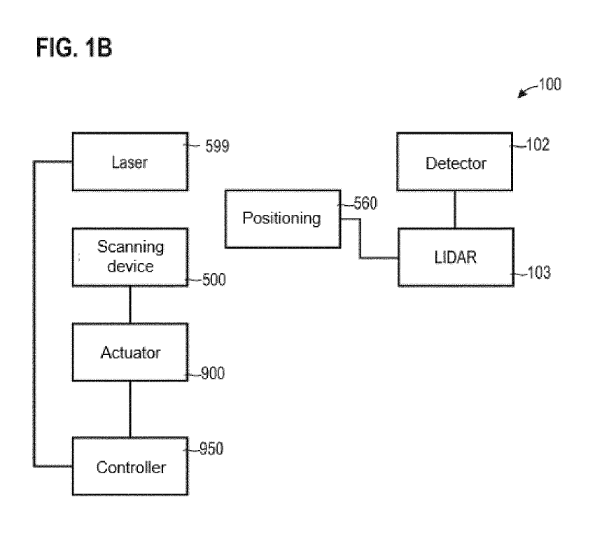

FIG. 1A illustrates aspects with respect to a scanned distance measurement of objects 195, 196. In particular, FIG. 1A illustrates aspects with respect to a distance measurement on the basis of the LIDAR technique.

FIG. 1A shows a device 100 comprising an emitter 101 for laser light 191, 192. The emitter 101 might be a laser light, for example, and/or one end of an optical fibers that emits laser light. The laser light is emitted in pulsed form for example (primary radiation). For example, the primary laser 191, 192 could be polarized. It would also be possible for the primary laser 191, 192 not to be polarized. The transit time of a laser light pulsed between the emitter 101, an object 195, 196 and a detector 102 may be fused to determine the distance between the device 100 and the objects 195, 196. To do so, secondary radiation 191B, 192B reflected by the objects 195, 196 is measured. The detector 102 may be for example, a photodiode which is coupled to a wavelength filter which allows light with wavelengths of laser light 191, 192 to pass through selectively. This makes it possible to detect the secondary laser light 191B, 192B reflected by the objects 195, 196 can be detected.

It is fundamentally possible for the emitter 101 and detector 102 to be implemented as separate components, but it would also be possible for the secondary laser light 191B, 192B to be detected by means of the same optical system also implemented by the emitter 101.

The detector 102 may comprise an avalanche photodiode, for example. The detector 102 may comprise a single photon avalanche diode (SPAD). For example, the detector may comprise a SPAD array comprising no less than 500, optionally no less than 1000, further optionally no less than 10,000 SPADs. The detector 102 can be operated for example, by means of photon correlation. The detector 102 may be equipped to detect individual photons, for example.

A LIDAR system 103 is provided and is coupled to the emitter 101 and the detector 102. For example, the LIDAR system may be equipped to achieve a chronological synchronization between the emitter 101 and the detector 102. The LIDAR system 103 may be equipped to carry out the distance measurement of the objects 195, 196 based on measurement signals received from the detector 102.

To be able to differentiate between the objects 195, 196—i.e., to be able to provide a high resolution—the emitter 101 is equipped to emit the laser light 191, 192 at various angles 110 (emission angles). Depending on the set angle 110, the laser light 191, 192 is thereby reflected by either the object 196 or the object 195. The high resolution can be provided while the LIDAR system 103 receives information about the respective angle 110. The image area within which the angles 110 in FIG. 1 can be varied is illustrated with a dotted line in FIG. 1. Different emission angles may correspond to different pixels of a LIDAR image.

FIG. 1B illustrates aspects with respect to the device 100. FIG. 1B illustrates the device 100 in greater detail than FIG. 1A.

In the example in FIG. 1B, the emitter 101 is implemented by a laser light source 599 and a scanning device 500. For example, the laser light source 599 might be a fiber laser or a laser diode. The laser light source 599 might excite for example, a plurality of spatial modes. The laser light source 599 might have a frequency range of 5-15 nm, for example.

The device 100 also comprises an actuator 900 which is equipped to actuate the scanning device 500. The scanning device 500 is equipped to deflect the laser light 191, 192 which is emitted by the laser light source 599 so that it is emitted at different angles 110. The scanning device 500 may enable a two-dimensional scanning of the surroundings.

The actuator 900 can typically be operated electrically. The actuator 900 could comprise magnetic components and/or piezoelectric components. For example, the actuator could comprise a rotational magnetic field source which is equipped to generate a magnetic field that rotates as a function of time. For example, the actuator may induce a stepwise torsion of the fiber by means of a dc component of the magnetic field and induce a resonant torsion of the fiber through an ac component of a magnetic field with a frequency coordinated with the resonant frequency.

A controller 950—for example, an electric circuit, a microcontroller, an FPGA, an ASIC and/or a processor etc.—is provided for controlling the actuator 900 and is equipped to send control signals to the actuator 900. The control 950 is equipped in particular to control the actuator 900 in such a way that it actuates the scanning device for scanning a certain angle range 110.

Furthermore, a positioning device 560 is provided in FIG. 1B. The positioning device 560 is optional. The positioning device 560 is equipped to output a signal which indicates the emission angle at which the laser light 191, 192 is emitted. To do so, it would be possible for the positioning device 560 to perform a measurement of the status of the actuator 900 and/or the scanning device 500. The positioning device 560 might also directly measure the primary laser light 191, 192, for example. In general, the positioning device 560 can measure the emission angle optically, e.g., based on the primary laser light 191, 192 and/or light of a light-emitting diode. The positioning device 560 could also receive control signals from the control 950 in a simple implementation and could determine the signal based on the control signals. Combinations of the aforementioned techniques are also possible.

The LIDAR system 103 can use the signal supplied by the positioning device 560 for scanned measurement of the distance of the objects. The LIDAR system 103 is also coupled to the detector 102. Based on the signal of the positioning device 560 and based on the secondary laser light 191B, 192B detected by the detector 102, the LIDAR system 103 can then perform the distance measurement of the objects 195, 196 in the surroundings of the device 100. The LIDAR system 103 can, for example, implement the high resolution of the distance measurement based on the signal of the positioning device 560. The LIDAR system 103 can output a plurality of LIDAR images, for example. The LIDAR images can be output at a certain image repeat rate, for example. For example, each LIDAR image may comprise a certain number of pixels. For example, each LIDAR image may map a certain image area in the surroundings of the device 100.

In one example, it would also be possible for the positioning device 560 to be connected to the controller 950 of the actuator 900 (not shown in FIG. 1B). Then a control loop could be implemented wherein the scanning device 500 is regulated based on the signal of the positioning device 560. The control loop could be implemented as an analog and/or digital loop. This means that the controller 950 can control the actuator 900 based on the signal of the positioning device 560. Then a reproducible scanning of the surroundings can be made possible. For example, measurement points of the LIDAR measurement can be detected repeatedly at the same emission angles. This can permit a particularly simple analysis.

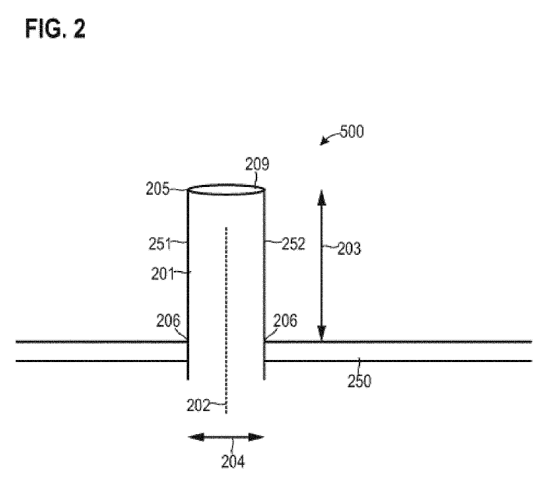

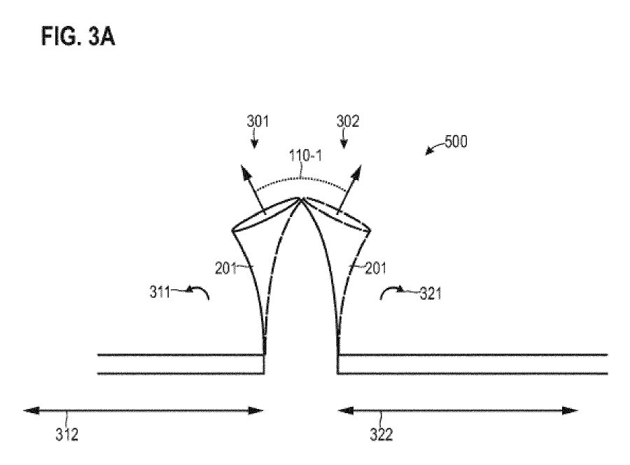

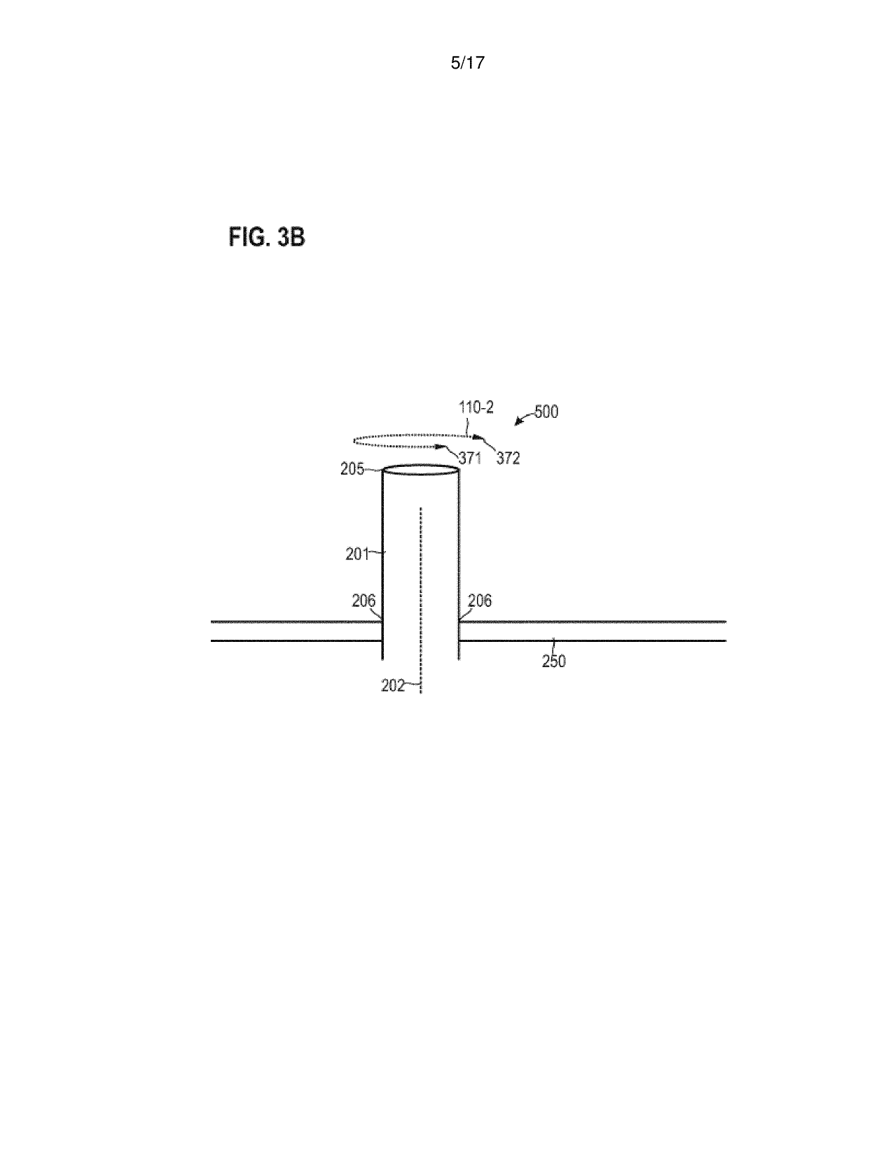

FIG. 2 illustrates aspects with respect to the device 100. FIG. 3 illustrates aspects with respect to the scanning device 500 in particular. In the example of FIG. 2, the device 100 comprises a fiber 201. The fiber 201 implements the scanning device 500. This means that the fiber 201 may be equipped to deflect laser light.

The fiber 201 extends along a central axis 202. The fiber 202 comprises a movable end 205 with an end face 209.

The device 100 also comprises a fixation 250. For example, the fixation 250 may be made of plastic or metal. The fixation 250 could be part of a housing, for example, which receives the movable end 250 of the fiber 201. The housing could be a DPAK or DPAK2 housing, for example.

The fixation 250 secures the fiber 201 at a fixation point 206. For example, the fixation 250 of the fiber 201 at the fixation point 206 could be implemented by a clamping device and/or by a solder connection and/or by an adhesive bond. In the area of the fixation point 206, the fiber 201 is therefore coupled to the fixation 250 in a rigid and/or stationary manner. FIG. 2 also illustrates the length 203 of the fiber 201 between the fixation point 206 and the movable end 205. It can be seen from FIG. 2 that the movable end 205 is at a distance from the fixation point 206. For example, in various examples, the length 203 may be in the range of 0.5 cm to 10 cm, optionally in the range of 1 cm to 5 cm, further optionally in the range of 1.5 to 2.5 mm.

The movable end 205 thus stands freely in space. Due to this distance of the movable end 205 from the fixation point 206, it is possible to achieve the result that the position of the movable end 205 of the fiber 201 can be altered with respect to the fixation point 206. For example, it is possible to curve and/or twist the fiber 201 in the area between the fixation point 206 and the movable end 205. FIG. 2 illustrates a resting state of the fiber 201 without any movement and/or deflection.

FIG. 3A illustrates some aspects with respect to the device 100. In particular FIG. 3A illustrates aspects with respect to the scanning device 500. In the example of FIG. 3A, the device 100 comprises a fiber 201. The fiber 201 implements the scanning device 500. The example of FIG. 3A corresponds to the example of FIG. 2. FIG. 3A shows a dynamic status of the scanning device 500.

In the example of FIG. 3A, the end 205 of the fiber 201 is illustrated in a position 301 and a position 302 (dashed line in FIG. 3A). These positions 301, 302 implement extreme positions of the fiber 201: for example, a stop might be provided to prevent further movement of the end 205 beyond the positions 301, 302 (not shown in FIG. 3A). The fiber 201 may move back and forth between the positions 301, 302 e.g., periodically. In the example of FIG. 3A, the position 301 corresponds to a curvature 311. The position 302 corresponds to a curvature 321. The curvatures 311, 321 have opposing plus or minus signs. The actuator 900 may be provided for moving the fiber 201 between the positions 301, 302 (the actuator 900 is not shown in FIG. 3A). The movement of the fiber between positions 301, 302 corresponds to a transverse mode of the fiber 201.

Whereas a one-dimensional movement (in the plane of the drawing of FIG. 3A) is illustrated in FIG. 3A, a two-dimensional movement (with a component perpendicular to the plane of the drawing in FIG. 3A) would also be possible. For example, a superimposed figure may be implemented by exciting the orthogonal degrees of freedom of the movement in accordance with transverse modes oriented at right angles to one another.

Providing the curvatures 311, 321 in positions 301, 302 achieves the result that the laser light 191, 192 is emitted over the curvature angle range 110-1. This makes it possible to scan the area of the surroundings of the device 100 by means of the laser light 191, 192. The laser light 191, 192 need not pass through the fiber 201. The primary laser light 191, 192 (not shown in FIG. 3A) may also arrive at the movable end 205 on another optical path.

In the example of FIG. 3A, an example of a radius of curvature 312 for the curvature 311 is also illustrated. Furthermore, an example of a radius of curvature 322 for the curvature 321 is also illustrated. The radii of curvature 312, 322 are each approximately 1.5 times larger than the length 203 of the fiber 201 between the fixation point 206 and the movable end 205. In other examples, weaker curvatures 311, 321 or stronger curvatures 311, 321 could also be implemented. Then weaker curvatures 311, 321 would correspond to larger radii of curvature 312, 322 in particular with respect to the length 203.

FIG. 3B illustrates aspects with respect to the device 100. In particular FIG. 3B illustrates aspects with respect to the scanning device 500. In the example of FIG. 3B the device 100 comprises a fiber 201. The fiber 201 implements the scanning device 500. The example of FIG. 3B corresponds to the example of FIG. 2. FIG. 3B shows a dynamic status of the scanning device 500.

In the example of FIG. 3B, the end 205 of the fiber 201 is moved in such a way that the fiber 201 is moved between a first torsion 371 and a second torsion 372 in the area between the fixation point 206 and the movable end 205. This corresponds to a torsion of the fiber 201 along the central axis 202. The fiber is excited according to a torsion mode. Providing the torsions 371, 372 achieves the result that the laser light 191, 192 (not shown in FIG. 3B) can be emitted over a corresponding torsion angle range 110-2, for example, in conjunction with a deflection unit (not shown in FIG. 3B). it is therefore possible to scan the surrounding area of the device 100 by means of the laser light 191, 192 (not shown in FIG. 3B). The laser light 191, 192 need not pass through the fiber 201. The primary laser light 191, 192 (not shown in FIG. 3A) can also reach the movable end 205 along another optical path.

A corresponding actuator may again be provided, equipped to implement the various torsions 371, 372. For example, the torsions 371, 372 illustrated in FIG. 3B may correspond to extreme positions of the movable end 205. For example, it would be possible for a corresponding stop to be provided, preventing any further twisting of the movable end 205 beyond the torsions 371, 372 (not shown in FIG. 3B). Alternatively or additionally, it would also be possible for the actuator to be equipped to prevent any further twisting of the movable end 205 beyond the torsions 371, 372. In FIG. 3B, the angle range 110-2 is again shown, which can be implemented for example, in cooperation with a deflecting unit (not shown in FIG. 3B) by means of the torsion 371, 372 of the movable end 205 of the fiber 201.

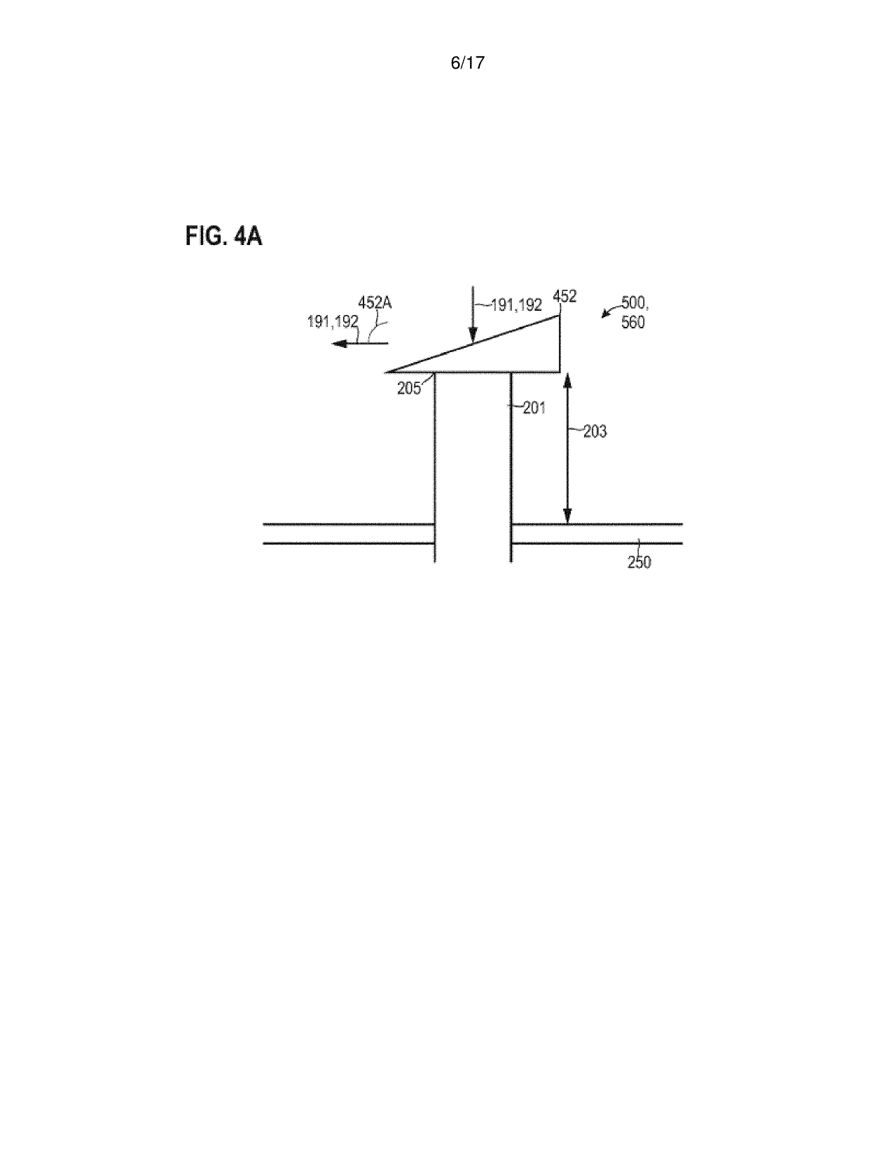

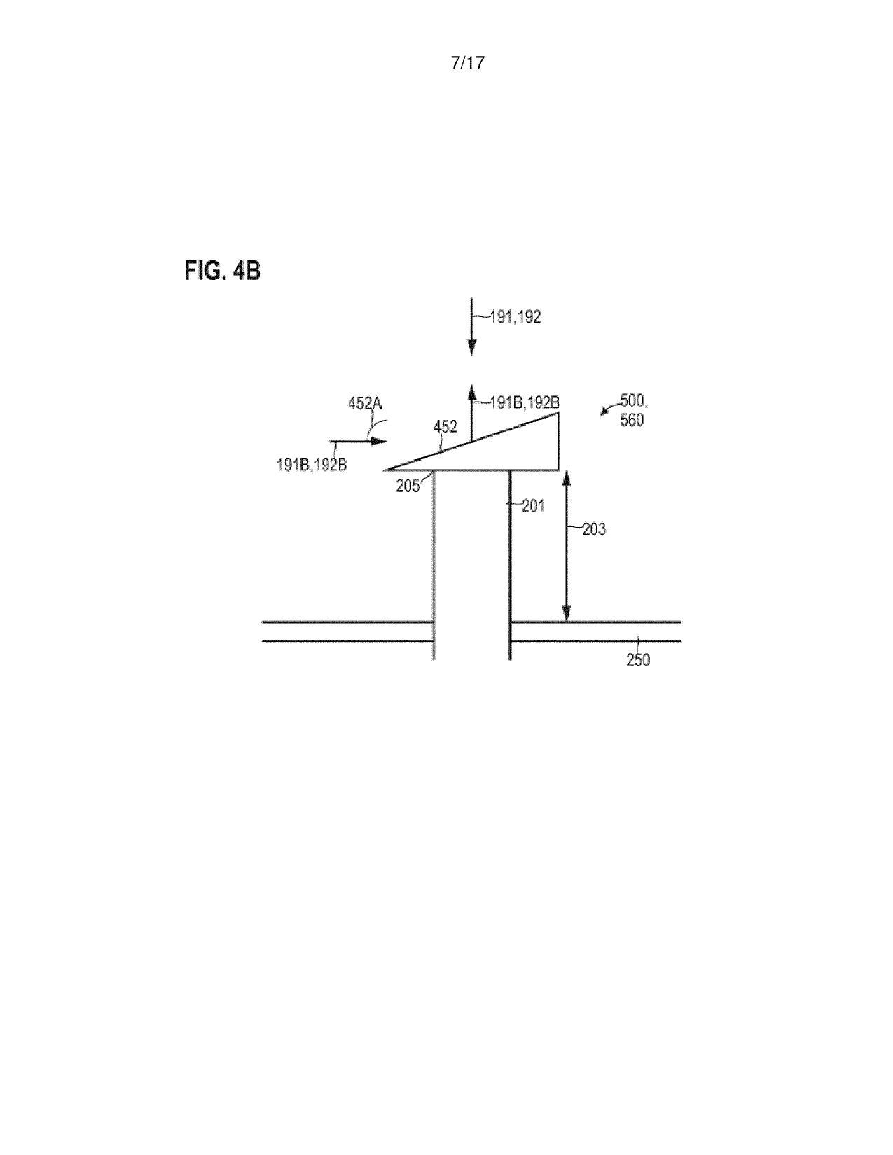

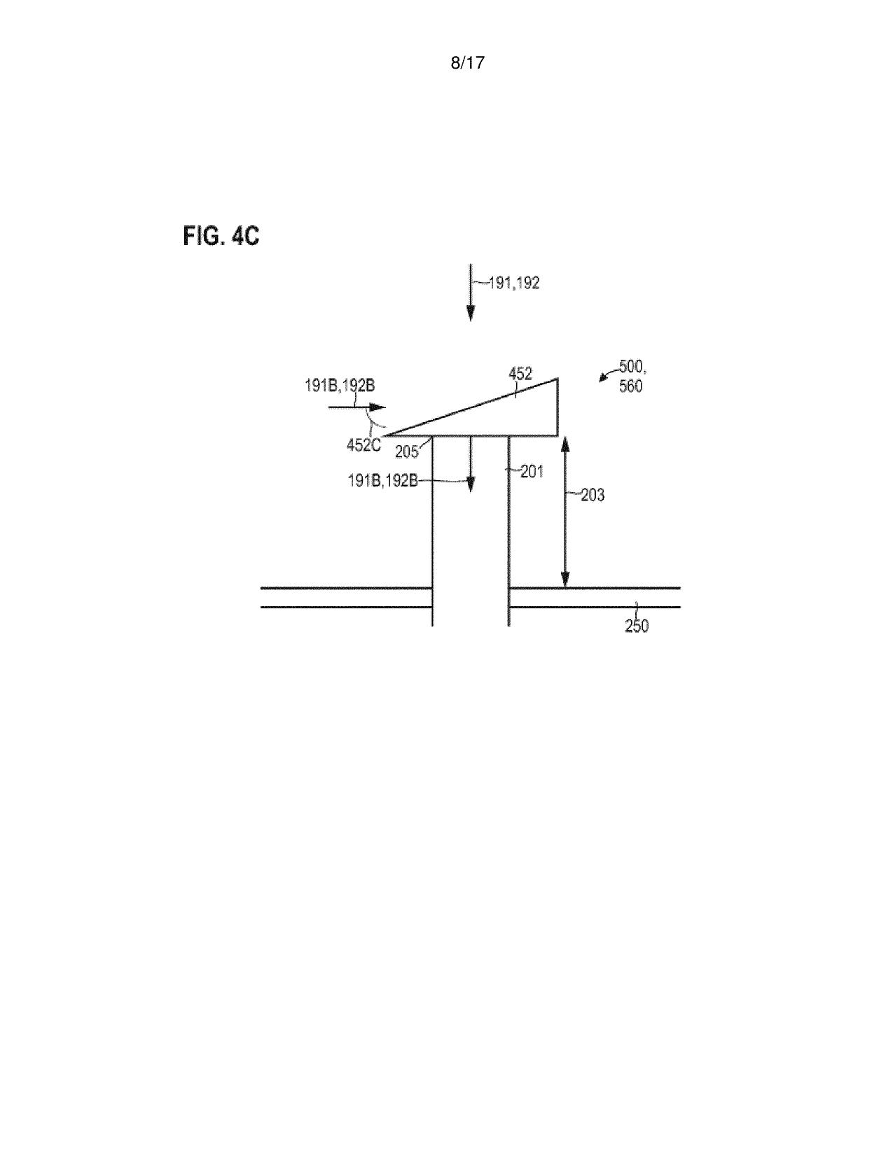

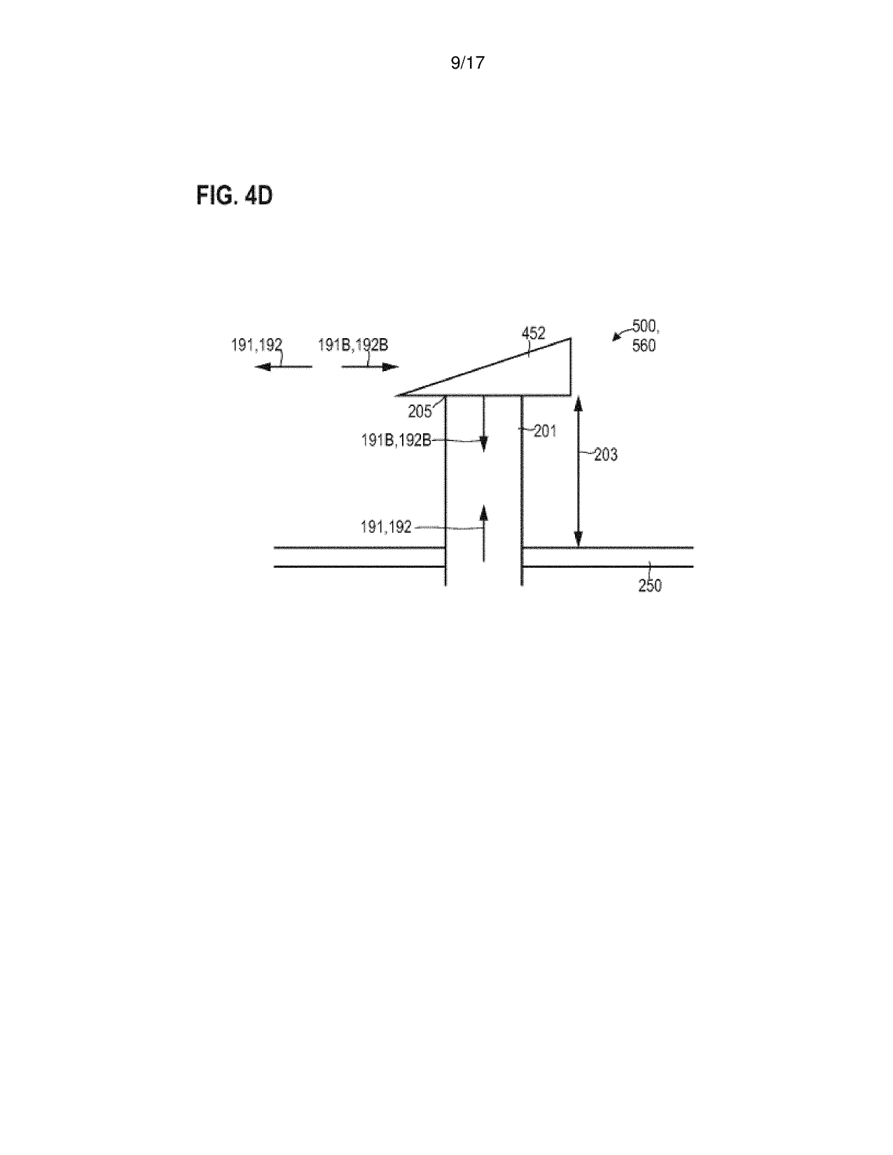

FIG. 4A illustrates aspects with respect to the device 100. FIG. 4A illustrates aspects with respect to the scanning device 500 in particular. In the example of FIG. 4A, the device 100 comprises a fiber 201. The fiber 201 implements the scanning device 500.

The example of FIG. 4A illustrates in particular the beam path of the primary laser light 191, 192. In the example of FIG. 4A, a deflecting unit 452 is connected to the movable end 205 of the fiber 201. A movement of the fiber 201 therefore causes a movement of the deflecting unit 452. For example, the deflecting unit 452 can be tilted by a curvature 311, 321 of the fiber 201 and/or rotated by torsion 371, 372 of the fiber 201. The deflecting unit 452 can be implemented for example, by a prism and/or a mirror.

The lateral dimension of the deflecting unit 452 (left-right in FIG. 4A; i.e., perpendicular to the central axis 202 of the fiber 201) is significantly greater than the width of the fiber 201 at a right angle to the central axis 202, for example, more than 1.5 times larger or more than twice as large or more than four times as large. For example, the deflecting unit 452 may have a diameter of more than 4 mm, optionally approximately 5 mm.

In the various examples described herein, it would be possible for the beam diameter of the primary laser light 191, 192 in the range of the deflecting unit 451 to be approximately 1.5 times greater than the diameter of the deflecting unit 451, optionally more than 2.5 times greater, further optionally more than 5 times greater. This means that the primary laser light 191, 192 can illuminate essentially the entire deflecting unit 451 and not just a small point on the deflecting unit 451. For example, the beam diameter of the primary laser light 191, 192 in the area of the deflecting unit 451 may be in the range of 1 to 5 mm and approximately 3 mm, for example.

In the example of FIG. 4A, primary laser light 191, 192 is directed at the deflecting unit 452. The laser light 191, 192 does not pass through the fiber 201. Therefore, this avoids a complex input of the laser light 191, 192 into an optical waveguide of the fiber 201 (if present at all, not shown in FIG. 4A), which would be complicated and subject to high losses. A particularly simple and inexpensive design is possible.

The deflecting unit deflects the primary laser light 191, 192 by a deflecting angle 452A. For example, the deflecting angle 452A might amount to approximately 90° or could be in the range between 45° and 135°, optionally in the range between 25° and 155°, further optionally in the range of 5° to 175°.

In the example of FIG. 4B, the deflecting unit 452 is connected to the fixation 250 only by the fiber 201—i.e., a one-point coupling of the deflecting unit 452 to the fixation 250 is implemented here. In other examples, the deflecting unit 452 might be connected to the fixation 250 by additional fibers (not shown in FIG. 4B) or by a guide, etc. Due to the connection of the deflecting unit 452 by means of only the fiber 201, a particularly great mobility of the deflecting unit 452 can be achieved. This can permit large angle ranges 110, 110-1, 110-2.

FIG. 4B illustrates aspects with respect to the device 100. FIG. 4A in particular illustrates aspects with respect to the scanning device 500. In the example of FIG. 4B the device 100 comprises a fiber 201. The fiber 201 implements the scanning device 500. The example of FIG. 4B illustrates in particular the beam path of the secondary laser light 191B, 192B.

In the example of FIG. 4B, the secondary laser light 191B, 192B is deflected by a deflecting angle 452B, which corresponds to the deflecting angle 452A. This makes it possible to achieve the result that the secondary laser light 191B, 192B takes the same optical path as the primary laser light 191, 192.

FIG. 4C illustrates aspects with respect to the device 100. In particular FIG. 4C illustrates aspects with respect to the scanning device 500. In the example of FIG. 4C the device 100 comprises a fiber 201. The fiber 201 implements the scanning device 500. The example of FIG. 4C illustrates in particular the beam path of the secondary laser light 191B, 192B.

In the example of FIG. 4C, the deflecting unit 452 also implements an optical element, which feeds secondary laser light 191B, 192B into an optical waveguide of fiber 201. For example, the deflecting unit 452 may implement a circulator. This means that the secondary laser light 191B, 192B is deflected at a different deflection angle 452C than the primary laser light 191, 192. In particular the circulator is equipped to input the secondary laser light 191B, 192B into an optical waveguide of the fiber 201. To do so, the primary laser light 191, 192 and the secondary laser light 191B, 192B may be polarized. This allows easy detection of the primary laser light 191, 192.

FIG. 4D illustrates aspects with respect to the device 100. FIG. 4A in particular illustrates aspects with respect to the scanning device 500. In the example of FIG. 4D, the device 100 comprises a fiber 201. The fiber 201 implements the scanning device 500. The example of FIG. 4D illustrates in particular the beam path of the secondary laser light 191B, 192B and of the primary laser light 191, 192.

In the example of FIG. 4D, the primary laser light 191, 192 is also passed through an optical waveguide of the fiber 201. Particularly accurate scanning may thus be possible. In addition, the deflecting unit 452 may be designed with comparatively small dimensions.

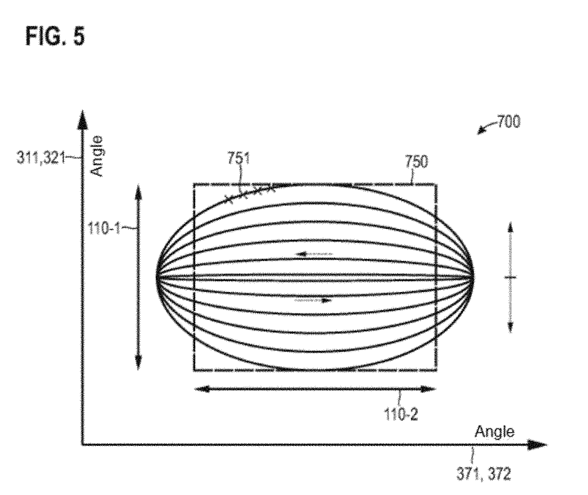

FIG. 5 illustrates aspects with respect to the scanning of the surroundings of the device 100 by moving the fiber 201. FIG. 5 in particular illustrates a superimposed FIG. 700, which is obtained when a first movement of the fiber (vertical axis in FIG. 5) with an amplitude that is variable over a period of time, is superimposed with a second movement of the fiber (horizontal axis in FIG. 5). Superpositioning of the movement means that the movements are carried out at least partially in parallel during the period of time and/or are excited by the actuator 900.

In the example of FIG. 5, a torsion 371, 372 of the fiber 201—which defines the angle range 110-2 (horizontal axis in FIG. 5)—is superimposed on a curvature 311, 321 of the fiber 201 (vertical axis in FIG. 5). This means that one of the two superimposed degrees of freedom of movement corresponds to a transverse mode of the fiber 201—for example, of the first or second order. Furthermore, the other one of the two superimposed degrees of freedom of movement corresponds to a torsion mode of the fiber—for example, of the first order. The horizontal arrows in FIG. 5 illustrate the direction of scanning of the superimposed FIG. 700. A particularly large field of surroundings can be scanned by superimposing the transverse mode on the torsion mode.

In doing so, the amplitude of the curvature 311, 321 is gradually increased over the period of time which is imaged by the superimposed FIG. 700. Therefore, the “eye” of the superimposed FIG. 700 becomes wider in the direction of the larger angles 110-2 (illustrated by the vertical broken-line arrows in FIG. 5). The maximum amplitude of the curvature 311, 321 here corresponds to the angle range 110-1.

At the same time, the amplitude of the torsion 371, 372 of the fiber (horizontal axis in FIG. 5) does not change in the example of FIG. 5 and is therefore constant. The superimposed FIG. 700 thus has a fixed left-right extent in FIG. 5, which corresponds to the angle range 110-2.

In other examples, it would be possible to vary the amplitude of torsion 371, 372 as well as the amplitude of the curvature 311, 321 of the fiber. In yet other examples, it would be possible to vary only the amplitude of torsion 371, 372 of the fiber.

The various branches of the superimposed FIG. 700 correspond to image lines of a LIDAR image, which is defined by an image range 750. The image range 750 is sometimes also referred to as the scan range. By repeated readout of the detector, pixels 751 can be obtained along the branches of the superimposed FIG. 700. For successive LIDAR images, the superimposed FIG. 700 is implemented repeatedly. The period of time required to implement the superimposed FIG. 700 therefore corresponds to the image repeat rate.

In the example of FIG. 5, the superimposed FIG. 700 does not have any nodes inside the image area 750. This has the advantage that there are no regions of the image area 750 that are scanned several times. The image repeat rate of the LIDAR system 103 can therefore be selected to be particularly high.

In the example of FIG. 5, the superimposed FIG. 700 is obtained by superimposing torsion 371, 372 on curvature 311, 321. In general, movements of different degrees of freedom of fiber 201 are superimposed on one another. For example, a first degree of freedom could correspond to a first transverse mode of the fiber 201, and the second degree of freedom could correspond to a second transverse mode of the fiber 201. Then, for example, the first and second transverse modes could have different polarizations relative to one another, i.e., being oriented in different directions in space (for example, in the plane of the drawing and perpendicular to the plane of the drawing in FIG. 3A). It would also be possible for the first and second transverse modes to be of different orders, i.e., have a different number of nodes and bulges. In yet other examples, the first movement and the second movement could correspond to torsion modes of different orders.

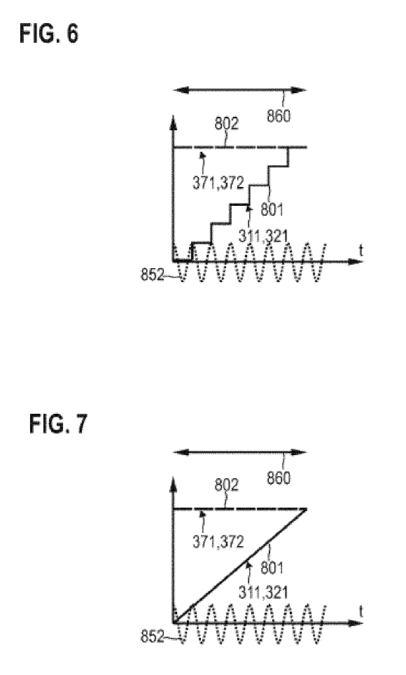

FIG. 6 illustrates aspects with respect to the amplitudes 801, 802 of the movements 311, 321, 371, 372 of the fiber 201 according to the example in FIG. 5. FIG. 6 in particular illustrates a time curve of amplitudes 801, 802. FIG. 6 illustrates the period of time 860 required to scan the superimposed FIG. 700 according to the example of FIG. 5. The period of time 860 may for example, correspond to the image repeat rate of the LIDAR system 103.

It can be seen from FIG. 6 that the amplitude 802 of the torsion 371, 372 remains constant during the period of time 860. It can also be seen from FIG. 6 that the amplitude 801 of the curvature 311, 321 is variable during the period of time 860. In the example of FIG. 6 the curvature 311, 321 has a monotonically increasing amplitude 801 during the period of time 860. In the example of FIG. 6 the amplitude 801 increases stepwise. The amplitude 801 might also decrease monotonically, for example.

FIG. 6 also illustrates aspects with respect to the instantaneous deflection 852 of the torsion 371, 372 as well as that of the curvature 311, 322 (dotted line in FIG. 6). It can be seen from FIG. 6 that the actuator 900 is equipped to excite the fiber 201 during the period of time 860 for the torsion 371, 372 and for the curvature 311, 321 at the same frequency, so that both torsion 371, 372 and curvature 311, 321 will have the same instantaneous deflection 852 as a function of time. If the different degrees of freedom of movement, which form the superimposed FIG. 700 are excited at the same frequency, then it is possible to achieve the result that the superimposed FIG. 700 does not have any nodes within the image area 750. Therefore, a high image repeat rate can be achieved for supplying the LIDAR images.

It can be seen from a comparison of FIGS. 5 and 6 that the steps of the step function according to which the amplitude 801 of the curvature 311, 321 is varied as a function of time, are each arranged at inversion points of the superimposed FIG. 700 (the outermost points of the superimposed FIG. 700, shown at the left and right in FIG. 5). A particularly uniform superimposed FIG. 700, which has well-defined lines within the image area 750, can therefore be achieved.

FIG. 7 illustrates aspects with respect to the amplitudes 801, 802 of the movements of the fiber 201 according to the example of FIG. 5. The example of FIG. 7 corresponding basically to the example of FIG. 6 but in the example of FIG. 7 the change in amplitude 801 of the curvature 311, 321 is linear as a function of time. In general, different time dependencies of the change in amplitudes 801, 802 can be implemented.

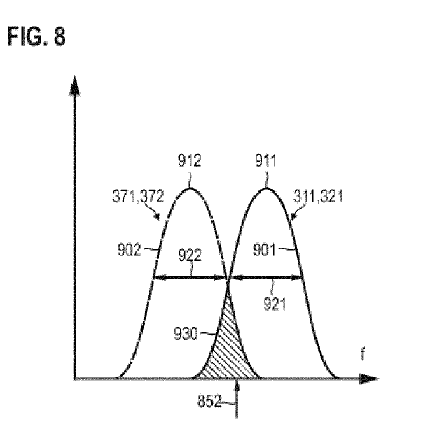

FIG. 8 illustrates aspects with respect to the resonant curves 901, 902 of the movements 311, 321, 371, 372 which form the superimposed FIG. 700 according to the example of FIG. 5. FIG. 8 illustrates the amplitude of the respective mode as a function of frequency.

FIG. 8 illustrates a resonance curve 901 of the curvature 311, 321 of the fiber 201. The resonance curve 901 has a maximum resonance 911 (solid line). The resonance curve 902 of torsion 371, 372 of the fiber 201 is also illustrated in FIG. 8 (dotted line). The resonance curve 902 has a maximum resonance 912.

For example, the resonance curve in 901, 902 may have a Lorentz shape. For example, this would be the case if the corresponding degrees of freedom of movement could be described by a harmonic oscillator.

The resonance peaks 911, 912 are shifted in frequency relative to one another. For example, the frequency interval between the peaks 911, 912 might be in the range of 5 kHz to 50 kHz.

FIG. 8 also illustrates a half-width 921 of the resonance curve 901. Furthermore, FIG. 8 shows a half-width 922 of the resonance curve 902. The half-width 921, 922 are typically defined by the damping of the corresponding movements 311, 321, 371, 372. In the example of FIG. 8, the half-widths 921, 922 are the same. In general, however, the half-widths 921, 922 may be different from one another.

In many examples, different techniques can be used to increase the half-widths 921, 922. For example, a suitable adhesive that affixes the fiber at the fixation point 206 might be provided.

The resonance curves 901, 902 have an overlap region 930 (region of hatching) in the example of FIG. 8. In the overlap region 930, both the resonance curve 901 and the resonance curve 902 have a significant amplitude. For example, it would be possible for the amplitudes of the resonance curves 901, 902 to be no less than 10% of the corresponding amplitudes at the respective resonance peaks around 911, 912 in the overlap region 930, optionally no less than 5%, further optionally no less than 1%. Due to the overlap region, it is possible to achieve the result that the two degrees of freedom of movement can be excited when coupled together. Therefore, the actuator 900 may have a particularly simple design.

For example, it would be possible for the frequency at which the actuator 900 drives the torsion 371, 372 as well as the curvature 311, 321 to be arranged in the overlap region 930 (represented by the signal shape 852 in FIG. 8). It is therefore possible to provide a resonant drive for both degrees of freedom of movement and thereby achieve comparatively large amplitudes of the movement of the fiber 201.

In other examples, however, it would also be possible for the resonance curves 901, 902 not to have any overlap region 930. In this way, there can be a particularly targeted excitation of the individual degrees of freedom of movement.

To adjust and/or shift the resonance curve 901, 902, one or more balancing weights that are mounted on the fiber 201 may be provided.

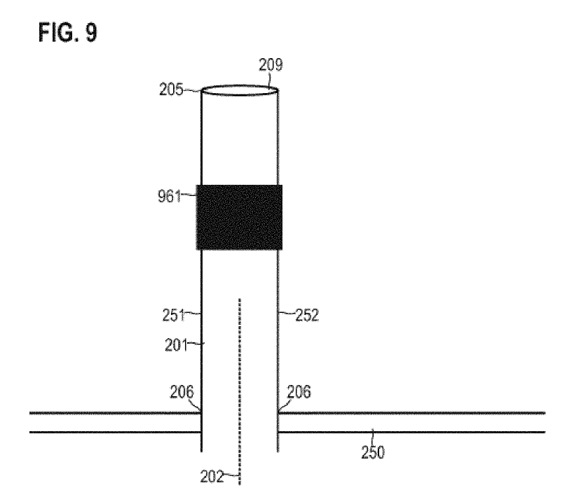

FIG. 9 illustrates aspects with respect to a balancing weight 961, which is mounted on the fiber 201 in the area between the movable end 205 and the fixation point 206. For example, the balancing weight 961 could be implemented by a ferrule. For example, the balancing weight may have a homogeneous or heterogeneous mass density as a function of the radius (perpendicular to the central axis 202). For example, the balancing weight 961 may be made of metal or plastic. The balancing weight 961 might be glued securely to the fiber 201, for example. Due to the balancing weight 961 it is possible in particular to shift the resonance curve 901 of the curvature 311, 321 toward lower frequencies. The overlap region 930 can therefore be created, and excitation of both degrees of freedom of movement is possible with one and the same frequency. It is therefore possible to achieve a superimposed figure without any nodes.

In many examples, the balancing weight 961 could also have an asymmetrical distribution of mass with respect to the central axis 202 and thereby result in an imbalance. Therefore, an imbalance of the fiber 201—which could have a negative effect on the torsion mode, for example—can be compensated.

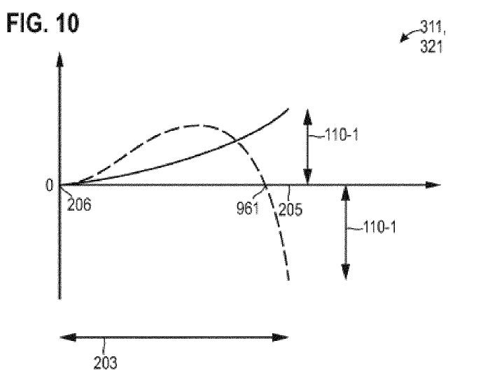

FIG. 10 illustrates aspects with respect to the balancing weight 961. In particular FIG. 10 illustrates aspects with respect to the fastening of the balancing weight 961 on the fiber 201. In the example of FIG. 10 the balancing weight 961 is mounted in the area of a node of the transverse mode of the second order of fiber 201 (dotted line in FIG. 10). For example, the curvature 311, 321 of the fiber 201 could be implemented by the transverse mode of the second order.

Due to such a fastening of the balancing weight 961 there may be a particularly great shift in the resonance curve 901.

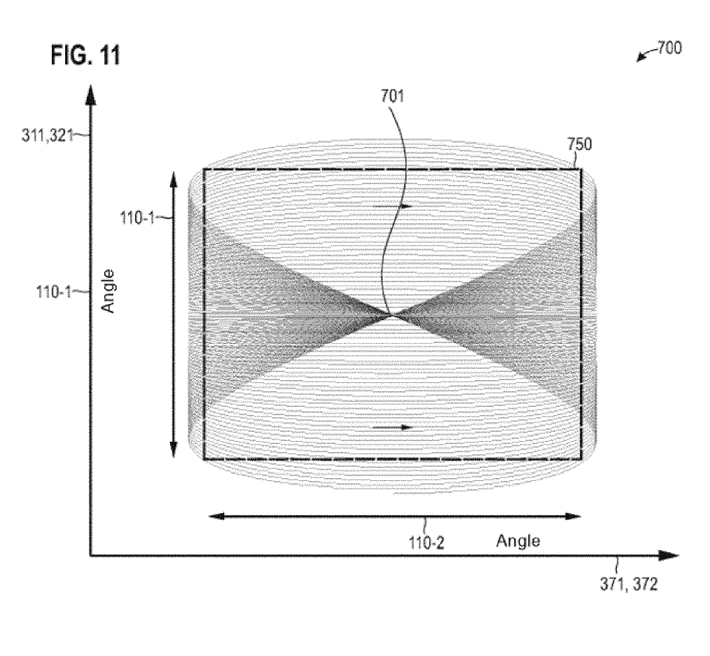

FIG. 11 illustrates aspects with respect to scanning the surroundings of the device 100 by moving the fiber 201. In particular FIG. 11 illustrates a superimposed FIG. 700 that is obtained when the curvature 311, 321 (vertical axis in FIG. 11) with an amplitude that is variable over a period of time 860 is superimposed on the torsion 371, 372 (horizontal axis in FIG. 11). The superpositioning of the movements 311, 321, 371, 372 means that the movements are carried out at least partially in parallel during the period of time and/or excited by the actuator 900.

The example of FIG. 11 corresponds fundamentally to the example of FIG. 5, but the actuator 900 in the example of FIG. 11 is equipped to excite the curvature 311, 321 at a frequency twice as great as the torsion 371, 372. The superimposed FIG. 700 therefore the has a node 701.

In other examples, a frequency three times greater is used for the curvature 311, 321 in comparison with the torsion 371, 372. Then the superimposed FIG. 700 would have two nodes.

Through a flexible choice of frequencies for the different movements, there can be a particularly flexible choice of the degrees of freedom of movement used.

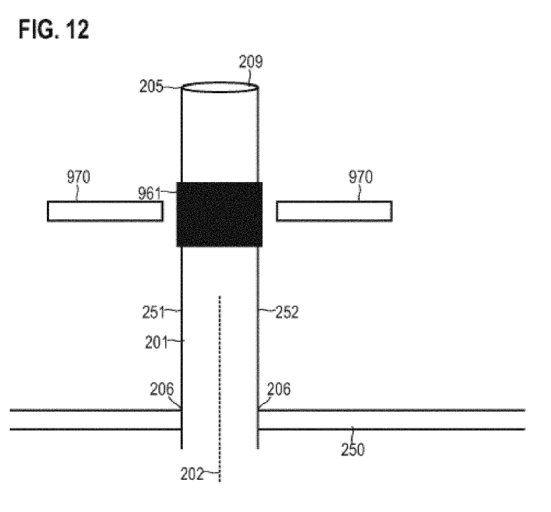

FIG. 12 illustrates aspects with respect to a stop 970. The stop 970 is equipped to limit the torsion 371, 372 of the fiber 201. To do so, the fiber 201 could have protrusions, for example (not shown in FIG. 12), which are brought into contact with the stop 970 at a suitably large torsion 371, 372 and in doing so suppress further twisting of the fiber 201.

By means of such a stop, it is possible to achieve the result that the torsion 371, 372 has a nonlinear force characteristic, for example, folded with a step function. It is possible in this way to achieve a superimposed figure having particularly sharp edges with respect to the angle range 110-2. Therefore a well-defined image range 750 can be achieved.

Alternatively or additionally, corresponding techniques with respect to the stop 970 can also be implemented with respect to a degree of freedom of movement corresponding to the curvature 311, 321, for example.

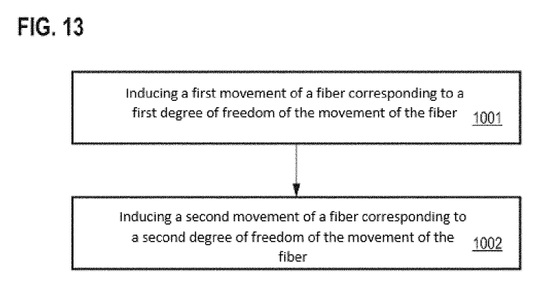

FIG. 13 shows a flow chart of an example of a method.

A first movement of the fiber according to a first degree of freedom is induced at 1001, for example, a transverse deflection of the fiber or a torsion of the fiber. In 1002 a second movement of al fiber according to a second degree of freedom is induced for example, a transverse deflection of the fiber or a torsion of the fiber. 1001 and 1002 may take place at least partially in parallel in time. For example, the torsion of the fiber could take place in steps in 1001 and therefore would not be resonant. Torsion of the fiber in 1002 could thus be resonant.

For example, the amplitude of the first movement and/or the second movement can be altered during the action of the movement in 1001 and/or in 1002, for example. To do so, an energizer current can be varied by an actuator for example, increased or decreased.

Laser light could optionally be deflected by the fiber. For example, primary laser light and optionally secondary laser light could be deflected by the fiber. Then a LIDAR image could be prepared on the basis of the detected secondary laser light.

The following examples in particular were described above:

### Example 1

Device (100) comprising:
a movable fiber (201) having a first degree of freedom of movement (311, 321, 371, 372) and a second degree of movement (311, 321, 371, 372) and being equipped to deflect movement (191, 192, 191B, 192B),
at least one actuator (900) which is equipped to induce a first movement (311, 321, 371, 372) of the fiber (201) according to the first degree of freedom during a period of time and to induce a second movement (311, 321, 371, 372) of the fiber (201) superimposed on the first movement (311, 321, 371, 372) in accordance with the second degree of freedom and
a LIDAR system (103), which is equipped to carry out a distance measurement of objects in the surroundings of the device (100) using a plurality of pixels, based on the movement (191, 192, 191B, 192B), wherein the pixels are arranged in a two-dimensional image area, which is defined by the first movement (311, 321, 371, 372) and the second movement (311, 321, 371, 372) during the period of time,
wherein the first movement (311, 321, 371, 372) has a variable amplitude (801, 802) during the period of time.

### Example 2

Device (100) according to Example 1,
wherein the at least one actuator (900) is equipped to excite the fiber (201) during the period of time for the first movement (311, 321, 371, 372) at a first frequency and to excite the fiber at a second frequency for the second movement (311, 321, 371, 372),
wherein the first frequency is the same as the second frequency or wherein the first frequency is equal to an integral multiple of the first frequency.

### Example 3

Device (100) according to Example 1 or 2
wherein the first degree of freedom has a first resonance curve (901, 902) having a first resonance maximum,
wherein the second degree of freedom is a first resonance curve (901, 902) having a second resonance maximum,
wherein the first resonance maximum has undergone a frequency shift in comparison with the second resonance maximum,
wherein in an overlap region (930) of the first resonance curve (901, 902) with the second resonance curve (901, 902), the amplitude of the first resonance curve (901, 902) is no less than 10% of the amplitude at the first resonance peak and also the amplitude of the second resonance curve (901, 902) is no less than 10% of the amplitude at the second resonance peak, optionally each being no less than 5%, further optionally no less than 1%.

### Example 4

Device (100) according to Examples 2 and 3,
wherein the first frequency and the second frequency are both in the overlap region (930).

### Example 5

Device (100) according to any one of the preceding examples,
wherein the first movement (311, 321, 371, 372) during the period of time has a monotonically variable amplitude (801, 802).

### Example 6

Device (100) according to any one of the preceding examples,
wherein the first movement (311, 321, 371, 372) has a nonlinear force characteristic and/or
wherein the second movement (311, 321, 371, 372) has a nonlinear force characteristic.

### Example 7

Device (100) according to any one of the preceding examples,
wherein the first degree of freedom of a transverse mode (311, 321) corresponds to the first or second order of the fiber (201),
wherein the second degree of freedom corresponds to a torsion mode (371, 372) of the fiber (201).

### Example 8

Device (100) according to any one of the preceding examples, additionally comprising:
a balancing weight (961) mounted on the fiber (201).

### Example 9

Device (100) according to Example 8,
wherein the balancing weight (961) is mounted in the area of a node of a transverse mode (311, 321) of the second order or higher order of the fiber (201).

### Example 10

Device (100) according to any one of the preceding examples, additionally comprising:
at least one stop (970) which limits the first movement (311, 321, 371, 372) and/or the second movement (311, 321, 371, 372) of the fiber (201).

The features of the embodiments and aspects of the invention described above can of course be combined with one another. In particular the features can be used not only in the combinations described here but also in other combinations or used separated without going beyond the scope of the invention.

For example, the superpositioning of a torsion with a curvature of the fibers is described above. In other examples other degrees of freedom of movement could be superimposed on one another in order to create a two-dimensional image area.

For example, various examples have been described above with respect to a constant amplitude of the torsion and a variable amplitude of the curvature. in other examples alternatively or additionally the amplitude of the torsion could also be varied.

1. A device comprising:
a movable fiber having a first degree of freedom of movement and a second degree of freedom of movement and
at least one actuator configured to induce, during a period of time, a first movement of the fiber corresponding to the first degree of freedom and a second movement of the fiber superimposed on the first movement, corresponding to the second degree of freedom,
wherein the first movement has a variable amplitude during the period of time.

2. The device according to claim 1, wherein the first degree of freedom corresponds to a torsion of a movable end of the fiber,
wherein the amplitude of the first movement is varied in increments.

3. The device according to claim 1, wherein the first degree of freedom corresponds to a resonant transverse mode of the first or second order of the fiber.

4. The device according to claim 1, wherein the second degree of freedom corresponds to a resonant torsion mode of the fiber.

5. The device according to claim 1,
wherein the at least one actuator is configured to excite the fiber during the period of time for the first movement at a first frequency and to excite the fiber at a second frequency for the second movement,
wherein the first frequency is the same as the second frequency or wherein the first frequency is the same as an integral multiple of the first frequency.

6. The device according to claim 1,
wherein the first degree of freedom has a first resonance curve with a first resonance peak,
wherein the second degree of freedom has a second resonance curve with a second resonance peak,
wherein the first resonance peak has a frequency shift with respect to the second resonance peak,
wherein the amplitude of the first resonance peak is no less than 10% of the amplitude at the second resonance peak in an overlap region of the first resonance curve with the second resonance curve, and also the amplitude of the second resonance curve is no less than 10% of the amplitude at the second resonance peak, optionally each being no less than 5%, further optionally no less than 1%.

7. The device according to claim 6,
wherein the at least one actuator is configured to excite the fiber during the period of time for the first movement at a first frequency and to excite the fiber at a second frequency for the second movement,
wherein the first frequency is the same as the second frequency or wherein the first frequency is the same as an integral multiple of the first frequency,
wherein the first frequency and the second frequency are in the overlap region.

8. The device according to claim 1, wherein the first movement during the period of time has a montonically variable amplitude or has an incrementally variable amplitude.

9. The device according to claim 1, additionally comprising:
a balancing weight mounted on the fiber.

10. The device according to claim 9, wherein the balancing weight is mounted in the area of a node of a transverse mode of the second order or higher order of the fiber.

11. The device according to claim 1, additionally comprising:
at least one stop which limits the first movement and/or the second movement of the fiber.

12. The device according to claim 1, additionally comprising:
a LIDAR system configured to carry out a distance measurement of objects in the surroundings of the device with a plurality of pixels based on the movement, wherein the pixels are arranged in a two-dimensional image area which is defined by the first movement and the second movement during the period of time.

13. The device according to claim 1, wherein the actuator comprises a rotary magnetic field source.

14. The device according to claim 13, wherein the rotary magnetic field source is configured to generate a magnetic field rotating as a function of time.

15. The device according to claim 13, wherein the rotary magnetic field source is configured to generate an incrementally variable magnetic field.

16. The device according to claim 1, wherein the second movement has a constant amplitude during the period of time.

17. A method, comprising:
inducing a first movement of a fiber corresponding to a first degree of freedom of the movement,
inducing a second movement of the fiber corresponding to a second degree of freedom of the movement,
wherein the inducing of the first movement and of the second movement takes place during a period of time so that the first movement and the second movement are superimposed,
wherein the first movement during the period of time has a variable amplitude.

18. The method according to claim 17,
wherein the first movement corresponds to an incremental torsion of the fiber,
wherein the second movement corresponding to a resonant torsion of the fiber.
